(19) United States
(12) Patent Application Publication
(10) Pub. No.: US 2026/0217179 A1
(43) Pub. Date: Jul. 30, 2026

(54) HINGE ASSEMBLY FOR A TRAILER GATE ON A UTILITY TRAILER

(71) Applicant: American Manufacturing Operations, Inc., Toledo, OH (US)

(72) Inventor: Jonathan R. SAUL, Lassale, MI (US)

(73) Assignee: American Manufacturing Operations, Inc., Toledo, OH (US)

(21) Appl. No.: 19/040,984

(22) Filed: Jan. 30, 2025

(51) Int. Cl. B60P 1/43

(52) U.S. Cl. CPC B60P 1/435; B60P 1/438

(57) ABSTRACT

A utility trailer includes a frame having a first side, a second side arranged opposite the first side, a forward end, and a rearward end. A trailer gate including a trailer gate frame is pivotally connected to the rearward end of the frame. The trailer gate frame including a first gate side, a second gate side arranged opposite the first side, a forward gate end and a rearward gate end. A hinge assembly connects the forward gate end of the trailer gate to the rearward end of the frame, the hinge assembly includes a hinge having a first hinge bracket and a second hinge bracket connected to the forward gate end. A hinge pin is supported between the first hinge bracket and the second hinge bracket. The hinge has an axis of rotation defined by the hinge pin that is vertically moveable relative to the trailer deck.

### FIELD

The present disclosure relates to the art of utility trailers and, more particularly, to a hinge assembly for a trailer gate on a utility trailer.

### BACKGROUND

This section provides background information related to the present disclosure and is not necessarily prior art.

Utility trailers serve a wide array of purposes. For example, utility trailers can be used to haul building materials, land scaping materials, furniture, garbage, vehicles, and the like. Utility trailers used to transport vehicles (e.g., cars, motorcycles, all-terrain vehicles (ATV’s), golf cart, etc.) can include a trailer deck and a folding trailer gate. The trailer gate is mounted to a rear edge of the utility trailer through a hinge. The hinge may be paired with a spring that helps a user move the trailer gate between deployed and stowed configurations. The trailer gate may be folded down and used as a ramp to load or unload the vehicle (or other cargo) onto the deck of the utility trailer.

When not being used as a ramp, the trailer gate may be folded upwardly and be arranged at a right angle relative to the trailer deck. In such a position, the vehicle or articles being transported have access to the entire trailer deck. While useful for loading, during transport the trailer gate may be a detriment. That is, positioned at a right angle relative to the trailer deck, the trailer gate generates drag that detracts from vehicle fuel efficiency. Even when the trailer gate is vented, e.g., made from expanded metal, the drag still has an impact of fuel efficiency.

In some configurations, when not being used as a ramp, the trailer gate may be folded fully forward to rest on the trailer deck. In order to allow the trailer gate to lie flat on the trailer deck, the hinge must be arranged above or even with the trailer deck. Positioning the hinge above or even with the trailer deck can create an obstacle to loading and/or unloading the utility trailer. Even when positioned at outboard sides of the trailer deck and trailer gate, the hinge, and more particularly, the spring, may be in a position to be engaged by a vehicle being loaded into the utility trailer. Repeatedly running a vehicle over the spring(s) will result in spring wear and premature spring failure.

### SUMMARY

This section provides a general summary of the disclosure and is not a comprehensive disclosure of its full scope or all of its features.

A utility trailer, in accordance with the present disclosure, includes a frame having a first side, a second side arranged opposite the first side, a forward end and a rearward end. The forward end and the rearward end extend between and connecting the first side and the second side. A trailer deck is mounted to the frame. A first wheel is mounted to the first side of the frame and a second wheel mounted to the second side of the frame. A trailer gate includes a trailer gate frame pivotally connected to the rearward end of the frame. The trailer gate frame includes a first gate side, a second gate side arranged opposite the first side, a forward gate end and a rearward gate end. The forward gate end and the rearward gate end extend between and connecting the first gate side and the second gate side. A hinge assembly connects the forward gate end of the trailer gate to the rearward end of the frame, the hinge assembly includes a hinge having a first hinge bracket and a second hinge bracket connected to the forward gate end. A hinge pin is supported between the first hinge bracket and the second hinge bracket, and a spring is arranged at the hinge and extending about the hinge pin. The hinge having an axis of rotation defined by the hinge pin that is vertically moveable relative to the trailer deck.

In other features, the hinge assembly is configured to accommodate rotation of the trailer gate between a deployed position in which the trailer gate extends rearwardly from the rearward end of the frame, a first stowed position wherein the trailer gate lies on the trailer deck, and a second stowed position wherein the trailer gate extends vertically upward from the trailer deck.

In other features, a hinge support bracket is mounted to the first side at the rearward end of the frame. The hinge support bracket includes a hinge support opening, the hinge pin extending through the hinge support opening.

In other features, the frame includes a frame rail that extends along the first side, the forward end, and the second side of the frame, the hinge support comprises a plate connected between the frame rail and the first side of the frame at the rearward end.

In other features, the hinge support opening comprises an arcuate slot formed in the plate.

In other features, the arcuate slot includes a first end and a second end that is vertically spaced above the first end and above the first side of the frame.

In other features, the hinge pin is disposed at the first end of the arcuate slot when the trailer gate is in the deployed position and when the trailer gate is in the second stowed position, and wherein the hinge pin is disposed at the second end of the arcuate slot when the trailer gate is in the first stowed position.

In other features, a locking element is arranged on the first gate side and a locking member is slidingly mounted to the frame rail, the locking member includes a first end selectively connectable with the locking element and a second end.

In other features, the forward gate end of the trailer gate comprises a U-shaped channel having a recess that extends between the first side and the second side.

In other features, at least a portion of the hinge and a portion of the spring is nested within the recess of the U-shaped channel forming the forward gate end of the trailer gate.

In other features, the spring includes an outside diameter (O.D.), and the forward gate end of the trailer gate is spaced from the rearward end of the frame by a gap that is less than the O.D. of the spring.

A utility trailer, in accordance with the present disclosure, a trailer deck including an upper support surface defined by a first side, a second side arranged opposite the first side, a forward end and a rearward end. The forward end and the rearward end extend between and connecting the first side and the second side. A trailer gate includes a trailer gate frame pivotally connected to the rearward end of the trailer deck. The trailer gate frame includes a first gate side, a second gate side arranged opposite the first side, a forward gate end and a rearward gate end. The forward gate end and the rearward gate end extend between and connecting the first gate side and the second gate side. A hinge assembly connects the forward gate end of the trailer gate to the rearward end of the trailer deck. The hinge assembly includes a hinge having a hinge pin supported at the forward gate end. The hinge pin defines an axis of rotation of the hinge assembly, wherein the axis of rotation selectively floats relative to the trailer deck.

In other features, the hinge assembly is configured to accommodate rotation of the trailer gate between a deployed position wherein the trailer gate extends rearwardly from the rearward end of the trailer deck, a first stowed position wherein the trailer gate lies on the upper support surface of the trailer deck, and a second stowed position wherein the trailer gate extends substantially perpendicularly relative to the upper support surface.

In other features, a hinge support bracket is mounted to the first side at the rearward end of the trailer deck. The hinge support bracket includes a hinge support opening. The hinge pin extends through the hinge support opening.

In other features, the trailer deck includes a rail that extends along the first side, the forward end, and the second side of the trailer deck, the hinge support comprises a plate connected between the rail and the first side of the trailer deck at the rearward end.

In other features, the hinge support opening comprises an arcuate slot formed in the plate.

In other features, the arcuate slot includes a first end and a second end that is vertically spaced above the first end and above the first side of the trailer frame.

In other features, the hinge pin is disposed at the first end of the arcuate slot when the trailer gate is in the deployed position and when the trailer gate is in the second stowed position, and wherein the hinge pin is disposed at the second end of the arcuate slot when the trailer gate is in the first stowed position.

In other features, a locking element is arranged on the first gate side and a locking member is slidingly mounted to the rail. The locking member includes a first end selectively connectable with the locking element and a second end.

In other features, the forward gate end of the trailer gate includes a U-shaped channel having a recess that extends between the first side and the second side.

In other features, the hinge assembly includes a spring extending about the hinge pin, at least a portion of the hinge and a portion of the spring is nested within the recess of the U-shaped channel forming the forward gate end of the trailer gate.

In other features, the spring includes an outside diameter (O.D.) and the forward gate end of the trailer gate is spaced from the rearward end of the frame by a gap that is less than the O.D. of the spring.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is an upper left perspective view of a utility trailer having a deployed trailer gate connected to a trailer deck through a hinge assembly, in accordance with the present disclosure;

FIG. 2 depicts the utility trailer showing the trailer gate resting on the trailer deck in a first stowed position, in accordance with the present disclosure;

FIG. 3 depicts a rear view of the utility trailer of FIG. 2 showing first and second hinges of the hinge assembly connecting the trailer gate to the trailer deck, in accordance with the present disclosure;

FIG. 4 depicts a rear view of the utility trailer showing the trailer gate extending upwardly from the trailer deck in a second, stowed configuration, in accordance with the present disclosure;

FIG. 5 depicts the first hinge assembly with the deployed trailer gate of FIG. 1, in accordance with the present disclosure;

FIG. 6 depicts the first hinge assembly mounted in a U-shaped channel forming a forward end of the trailer gate, in accordance with the present disclosure;

FIG. 7 depicts the first hinge with the trailer gate in the first stowed configuration of FIG. 3, in accordance with the present disclosure;

FIG. 8 depicts the first hinge with the trailer gate in the second stowed configuration of FIG. 4 prior to being secure by a locking member, in accordance with the present disclosure; and

FIG. 9 depicts the first hinge with the trailer gate in the second stowed configuration of FIG. 8 after to being secure by a locking member, in accordance with the present disclosure.

Corresponding reference numerals indicate corresponding parts throughout the several views of the drawings.

### DETAILED DESCRIPTION

Example embodiments will now be described more fully with reference to the accompanying drawings.

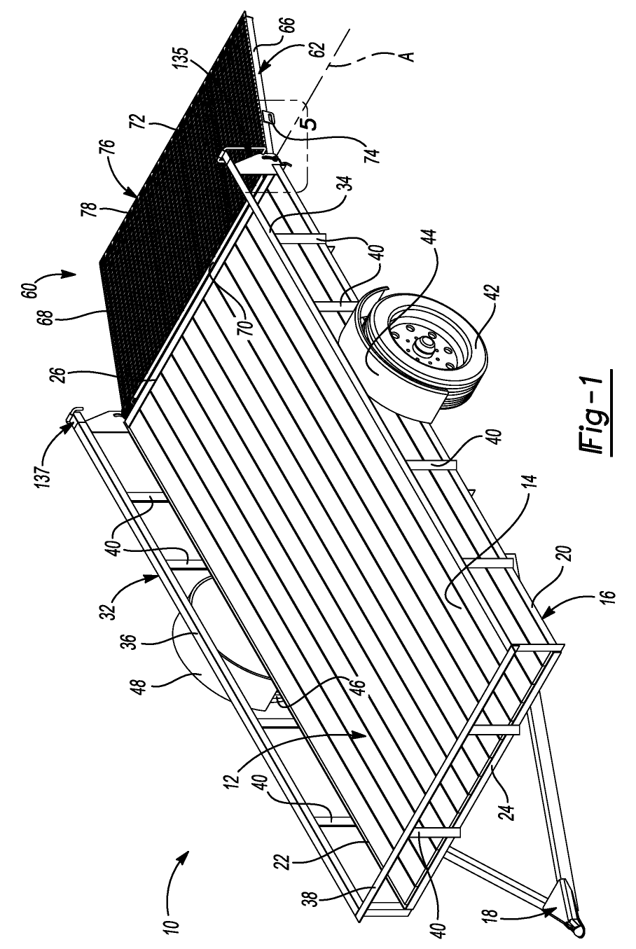

A utility trailer, in accordance with a non-limiting example, is indicated generally at 10 in FIGS. 1, 2, 3, and 4. Utility trailer 10 includes a trailer deck 12 having an upper support surface 14 supported by a frame 16 having a tow bracket (or coupler) 18. Upper support surface 14 is formed by a plurality of wooden planks (not separately labeled). Frame 16 includes a first side 20, a second side 22 that extends substantially parallel to first side 20, a forward and 24, and a rearward end 26. Forward end 24 and rearward end 26 extend between and connect with first side 20 and second side 22. Tow bracket 18 is connected at forward end 24.

Utility trailer 10 includes a rail system 32 that circumscribes a portion of trailer deck 12. In a non-limiting example, rail system 32 includes a first rail 34 that extends along first side 20, a second rail 36 that extends along second side 22, and a third rail 38 that extends along forward end 24 and connects between first rail 34 and second rail 36. Rail system 32 is connected to frame 16 though a plurality of rail supports indicated at 40. Utility trailer 10 is further shown to include a first wheel 42 having a first fender 44 supported at first side 20 and a second wheel 46 having a second fender 48 supported at second side 22. The number of wheels may vary. Each wheel 42, 46 may have an independent axle (not shown) or be supported by a common axle (also not shown).

In accordance with the present disclosure, utility trailer 10 includes a trailer gate 60 having a trailer gate frame 62 including a first gate side 66, a second gate side 68 that is substantially parallel to first gate side 66, a forward gate end 70 that is pivotally attached to rearward end 26 of frame 16 and a rearward gate end 72, and a plurality of gate supports 73. First gate side 66 supports a first locking element 74 and second gate side 68 supports a second locking element 75. First and second locking elements 74, 75 may be plates or tabs welded to (or otherwise fixed to) the trailer gate frame 62 and having openings (e.g., slots) formed therein. Trailer gate frame 62 is covered (or partially covered) by a gate surface 76 formed from, in the non-limiting example shown, expanded metal 78. Forward gate end 70 may include a U-shaped channel 80 having a recess 82 that extends between first gate side 66 and second gate side 68.

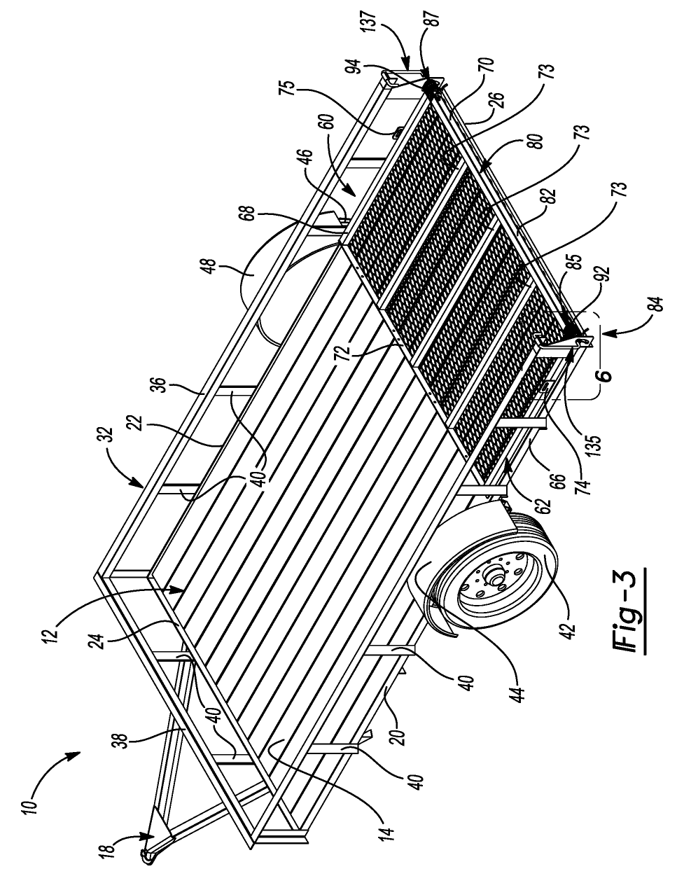

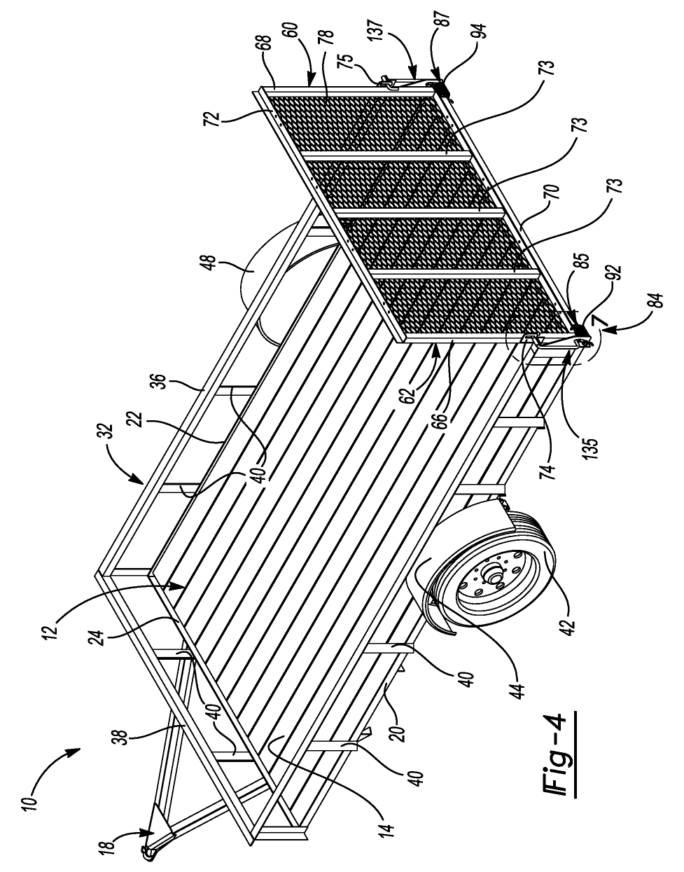

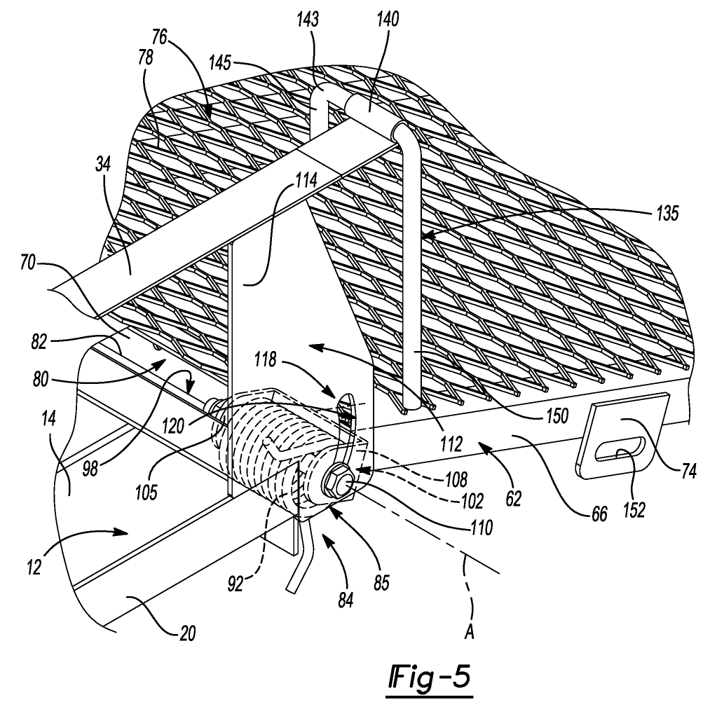

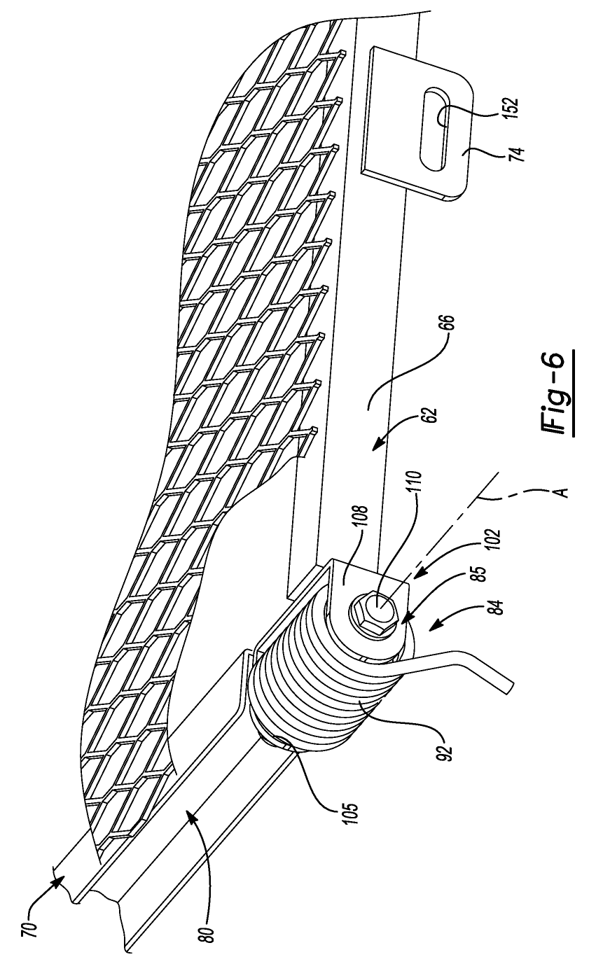

Trailer gate 60 includes a hinge assembly 84 including a first hinge 85 and a second hinge 87. As shown in FIGS. 3 and 4, first hinge 85 includes a first assist spring 92 having a first outer diameter (O.D.) and second hinge 88 includes a second assist spring 94 having a second O.D. In accordance with a non-limiting example, first O.D. and second O.D. is between about 1.5-inches (3.8-cm) and about 2.5-inches (6.35-cm). In another non-limiting example, the first O.D. and the second O.D, is about 2-inches (5.1-cm). Of course, the particular outer dimension of each assist spring 92 and 94 may vary. As shown in FIGS. 5 and 6, first assist spring 92 and second assist spring 94 are nested, in part, within recess 82 formed by U-shaped channel 80. With this arrangement, a gap 98 that exists between rearward end 26 of frame 16 and forward gate end 70 of trailer gate 60 is smaller than the each of the first O.D. and the second O.D. for corresponding ones of first assist spring 92 and second assist spring 94.

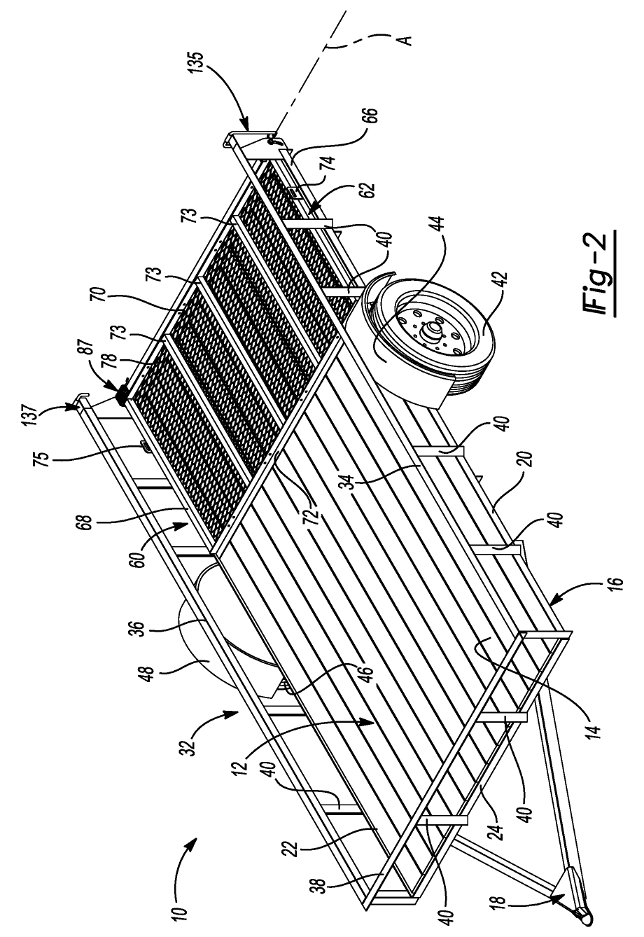

Hinge assembly 84 allows trailer gate 60 to pivot relative to trailer deck 12 between a deployed position or ramp position (FIG. 1) in which trailer gate 60 extends rearward and downward from rearward end 26 of frame 16 with rearward gate end 72 contacting the ground to form a ramp), a first stowed position or forward-folded position (FIGS. 2 and 3; in which trailer gate 60 extends from the rearward end 26 of frame 16 toward the forward end 24 of frame 16 and lies generally flat on trailer deck 12), and a second stowed position or upright position (FIG. 4) in which trailer gate 60 projects upwardly from trailer deck 12 (i.e., such that rearward gate end 72 is disposed above forward end 24 and trailer deck 12).

Reference will continue to FIGS. 5, 6, and 7 in describing first hinge 85 with an understanding that second hinge 87 includes similar or identical structure. First hinge 85 includes a first hinge support 102 having a first hinge bracket 105 (e.g., a first tab) including a first opening (not separately labeled) and a second hinge bracket 108 (e.g., a second tab) having a second opening (also not separately labeled) secured to forward gate end 70 of trailer gate frame 62. More specifically, first hinge support 102 is mounted in recess 82 of U-shaped channel 80 which forms forward gate end 70. In this manner, forward gate end 70 provides additional structural support to first hinge 85 and second hinge 87. Hinge brackets 105, 108 may cooperate to form a generally U-shaped configuration of the hinge bracket. A hinge pin 110 passes through the first opening in first hinge bracket 105 and the second opening formed in second hinge bracket 108. First assist spring 92 extends about hinge pin 110 defining an axis of rotation “A” for first hinge 85. First assist spring 92 is grounded to each of rearward end 26 of frame 16 and forward gate end 70 of trailer gate 60.

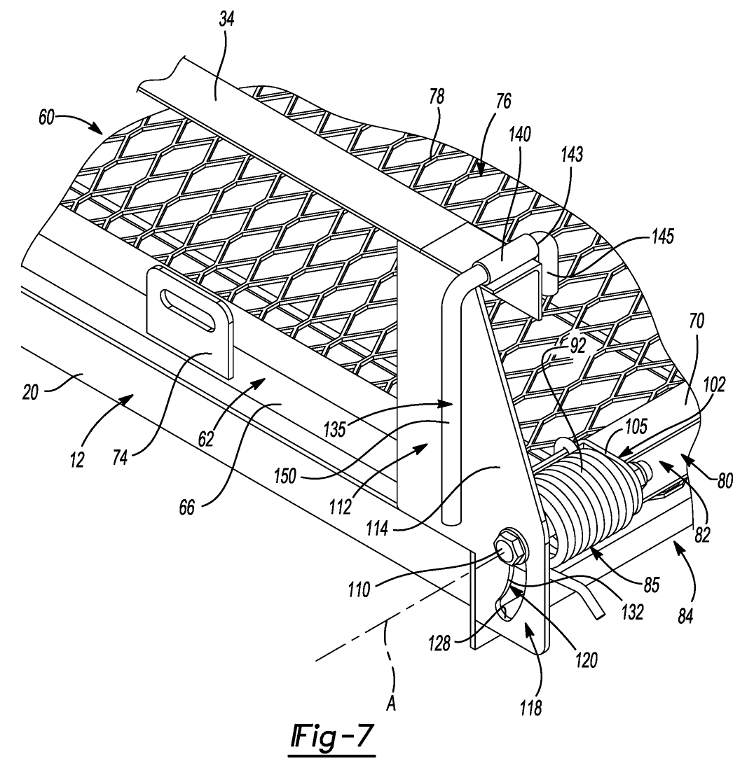

In accordance with the present disclosure, hinge assembly 84 also includes a pair of hinge support brackets 112 fixedly mounted to first side 20 and second side 22, respectively, at rearward end 26 of frame 16. Hinge support brackets 112 may be plates 114 having a hinge support opening 118. In accordance with a non-limiting example, hinge support opening 118 is an arcuate slot 120 having a first end 128, a second end 130, and a curvilinear intermediate portion 132. Arcuate slot 120 is arranged generally vertically such that first end 128 is disposed vertically lower than second end 130. Hinge pin 110 extends into hinge support opening 118. In other words, hinge pin 110 extends through arcuate slot 120 and is movable within arcuate slot 120 between a first position (in which hinge pin 110 is disposed at first end 128) and a second position (in which hinge pin 110 is disposed at second end 130). When trailer gate 60 is in the deployed position, hinge pin 110 is disposed at first end 128 (FIG. 5). In the first stowed configuration, hinge pin 110 is disposed at second end 130 (FIG. 6). When in the second stowed configuration, hinge pin 110 is disposed at first end 128 (FIG. 7).

Hinge pins 110 of first and second hinges 85, 87 define an axis of rotation “A” about which trailer gate 60 rotates relative to trailer deck 12. In a non-limiting example, the axis of rotation “A” of first and second hinges 85 and 87 translates or floats relative to upper support surface 14 when trailer gate 60 is moved between the deployed position, the first stowed configuration, and the second stowed configuration. More specifically, by moving the hinge pins 110 between first and second ends 128, 130 of arcuate slot 120, the rotational axis of the trailer gate 60 is movable between a first position (e.g., when trailer gate 60 is in the deployed position and in the second stowed position) that is below upper support surface 14 of trailer deck 12 and a second position (e.g., when trailer gate 60 is in the first stowed position) that is above upper support surface 14 of trailer deck 12.

The particular geometry of arcuate slot 120 allows hinge assembly 84 to be arranged substantially vertically offset below trailer deck 12 and gate surface 76 in recess 82 of U-shaped channel 80 when trailer gate 60 is in the deployed position. In this manner, hinge assembly 84 is shielded from damage that may be caused by loading and unloading utility trailer 10 and further ensures that a full width of trailer deck 12/trailer gate 60 is available and not narrowed due to the presence of first hinge 85 and second hinge 87 being exposed.

In accordance with a non-limiting example, utility trailer 10 includes a first locking member 135 mounted to first rail 34 and a second locking member 137 mounted to second rail 36. For example, first and second locking members 135, 137 may be hooks (e.g., bars with bends) that are configured to lock trailer gate 60 in the second stowed position. As first and second locking members 135, 137 are similarly or identically formed, a detailed description will follow to FIGS. 7, 8, and 9 in describing first locking member 135 with an understanding that second locking member 137 includes similar features. In the non-limiting example shown, a sleeve 140 is fixedly mounted to first rail 34 near rearward end 26. First locking member 135 is slidingly received in sleeve 140. First locking member 135 includes a first end portion 143 having a locking element connector 145 and a second end portion 150. Locking element connector 145 passes through a lock opening 152 formed in first locking element 74.

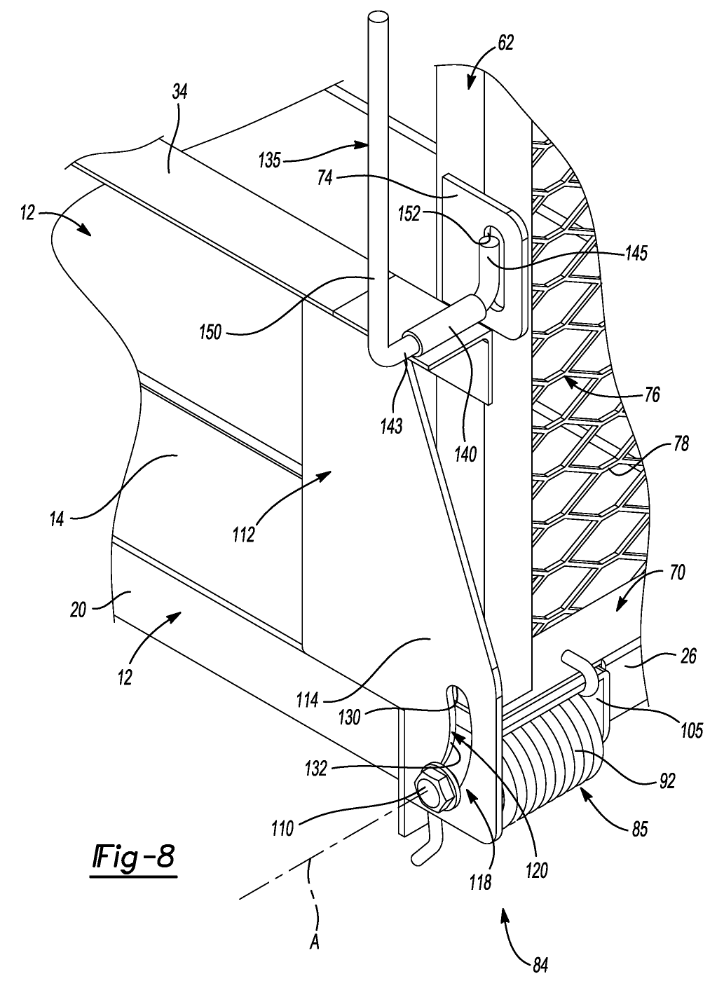

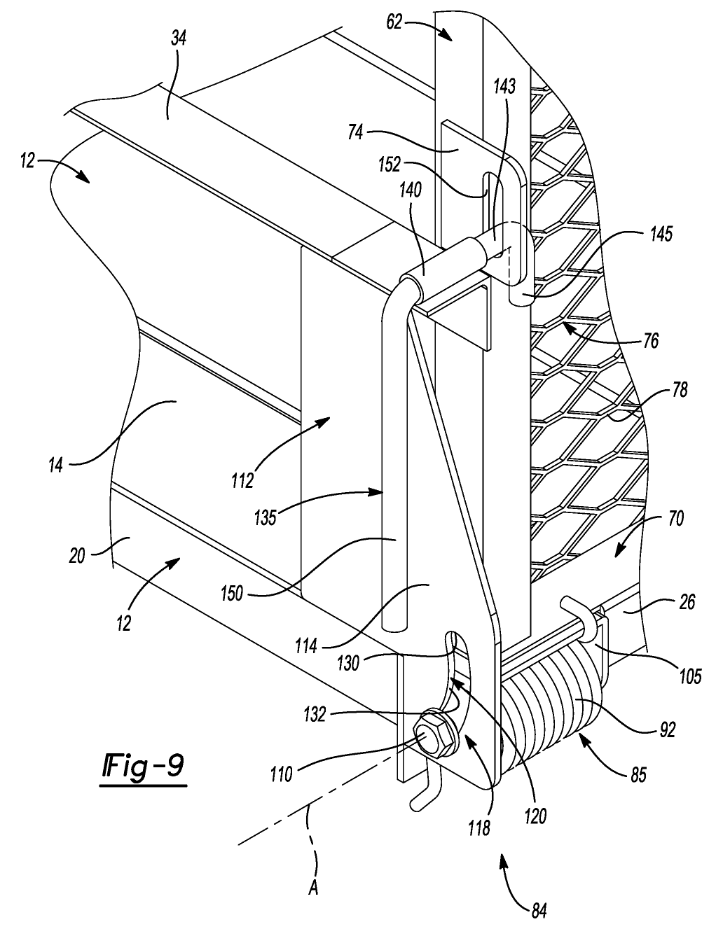

First locking member 135 engages with first locking element 74 when trailer gate 60 is in the second stowed configuration. More specifically, after trailer gate 60 is raised into the second, stowed configuration, first locking member 135 is rotated about sleeve 140 from a first position (FIG. 7) to a second position (FIG. 8). First locking member 135 is then shifted through sleeve 140 until locking element connector 145 is inserted through lock opening 152 (FIG. 9) in locking element 74. Once in that position, first locking member 135 may be rotated so that second end portion 150 is directed downwardly.

In this position, interference between the locking element connector 145 and first locking element 74 prevents the locking element connector 145 from being removed from the slot of the first locking element 74. Further, as hinge pin 110 is located at first end 128 of arcuate slot 120 (FIG. 8), trailer gate 60 is prevented from moving upwardly in such a way that would allow locking element connector 145 to back out of lock opening 152 during transit. Trailer gate 60 may be unlocked by reversing the above-described steps.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected, or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below”, or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

The terms “about” and substantially are intended to include the degree of error associated with measurement of the particular quantity based upon the equipment available at the time of filing the application. For example, “about” and “substantially” can include a range of ± 8% of a given value.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A utility trailer comprising:
a frame having a first side, a second side arranged opposite the first side, a forward end and a rearward end, the forward end and the rearward end extending between and connecting the first side and the second side;
a trailer deck mounted to the frame;
a first wheel mounted to the first side of the frame and a second wheel mounted to the second side of the frame;
a trailer gate including a trailer gate frame pivotally connected to the rearward end of the frame, the trailer gate frame including a first gate side, a second gate side arranged opposite the first side, a forward gate end and a rearward gate end, the forward gate end and the rearward gate end extending between and connecting the first gate side and the second gate side; and
a hinge assembly connecting the forward gate end of the trailer gate to the rearward end of the frame, the hinge assembly including a hinge having a first hinge bracket and a second hinge bracket connected to the forward gate end, a hinge pin supported between the first hinge bracket and the second hinge bracket, and a spring arranged at the hinge and extending about the hinge pin, the hinge having an axis of rotation defined by the hinge pin that is vertically moveable relative to the trailer deck.

2. The utility trailer according to claim 1, wherein the hinge assembly is configured to accommodate rotation of the trailer gate between a deployed position in which the trailer gate extends rearwardly from the rearward end of the frame, a first stowed position wherein the trailer gate lies on the trailer deck, and a second stowed position wherein the trailer gate extends vertically upward from the trailer deck.

3. The utility trailer according to claim 2, further comprising a hinge support bracket mounted to the first side at the rearward end of the frame, the hinge support bracket including a hinge support opening, the hinge pin extending through the hinge support opening.

4. The utility trailer according to claim 3, wherein the frame includes a frame rail that extends along the first side, the forward end, and the second side of the frame, the hinge support comprises a plate connected between the frame rail and the first side of the frame at the rearward end.

5. The utility trailer according to claim 4, wherein the hinge support opening comprises an arcuate slot formed in the plate.

6. The utility trailer according to claim 5, wherein the arcuate slot includes a first end and a second end that is vertically spaced above the first end and above the first side of the frame.

7. The utility trailer according to claim 6, wherein the hinge pin is disposed at the first end of the arcuate slot when the trailer gate is in the deployed position and when the trailer gate is in the second stowed position, and wherein the hinge pin is disposed at the second end of the arcuate slot when the trailer gate is in the first stowed position.

8. The utility trailer according to claim 6, further comprising:
a locking element arranged on the first gate side; and
a locking member slidingly mounted to the frame rail, the locking member including a first end selectively connectable with the locking element and a second end.

9. The utility trailer according to claim 8, wherein the forward gate end of the trailer gate comprises a U-shaped channel having a recess that extends between the first side and the second side.

10. The utility trailer according to claim 9, wherein at least a portion of the hinge and a portion of the spring is nested within the recess of the U-shaped channel forming the forward gate end of the trailer gate.

11. The utility trailer according to claim 10,
wherein the spring includes an outside diameter (O.D.), and
wherein the forward gate end of the trailer gate is spaced from the rearward end of the frame by a gap that is less than the O.D. of the spring.

12. A utility trailer comprising:
a trailer deck including an upper support surface defined by a first side, a second side arranged opposite the first side, a forward end and a rearward end, the forward end and the rearward end extending between and connecting the first side and the second side;
a trailer gate including a trailer gate frame pivotally connected to the rearward end of the trailer deck, the trailer gate frame including a first gate side, a second gate side arranged opposite the first side, a forward gate end and a rearward gate end, the forward gate end and the rearward gate end extending between and connecting the first gate side and the second gate side; and
a hinge assembly connecting the forward gate end of the trailer gate to the rearward end of the trailer deck, the hinge assembly including a hinge having a hinge pin supported at the forward gate end, the hinge pin defining an axis of rotation of the hinge assembly, wherein the axis of rotation selectively floats relative to the trailer deck.

13. The utility trailer according to claim 12, wherein the hinge assembly is configured to accommodate rotation of the trailer gate between a deployed position wherein the trailer gate extends rearwardly from the rearward end of the trailer deck, a first stowed position wherein the trailer gate lies on the upper support surface of the trailer deck, and a second stowed position wherein the trailer gate extends substantially perpendicularly relative to the upper support surface.

14. The utility trailer according to claim 13, further comprising a hinge support bracket mounted to the first side at the rearward end of the trailer deck, the hinge support bracket including a hinge support opening, the hinge pin extending through the hinge support opening.

15. The utility trailer according to claim 14, wherein the trailer deck includes a rail that extends along the first side, the forward end, and the second side of the trailer deck, the hinge support comprises a plate connected between the rail and the first side of the trailer deck at the rearward end.

16. The utility trailer according to claim 15, wherein the hinge support opening comprises an arcuate slot formed in the plate.

17. The utility trailer according to claim 16, wherein the arcuate slot includes a first end and a second end that is vertically spaced above the first end and above the first side of the trailer frame.

18. The utility trailer according to claim 17, wherein the hinge pin is disposed at the first end of the arcuate slot when the trailer gate is in the deployed position and when the trailer gate is in the second stowed position, and wherein the hinge pin is disposed at the second end of the arcuate slot when the trailer gate is in the first stowed position.

19. The utility trailer according to claim 16, further comprising:
a locking element arranged on the first gate side; and
a locking member slidingly mounted to the rail, the locking member including a first end selectively connectable with the locking element and a second end.

20. The utility trailer according to claim 19, wherein the forward gate end of the trailer gate includes a U-shaped channel having a recess that extends between the first side and the second side.

21. The utility trailer according to claim 19, wherein the hinge assembly includes a spring extending about the hinge pin, at least a portion of the hinge and a portion of the spring is nested within the recess of the U-shaped channel forming the forward gate end of the trailer gate.

22. The utility trailer according to claim 21,
wherein the spring includes an outside diameter (O.D.), and
wherein the forward gate end of the trailer gate is spaced from the rearward end of the frame by a gap that is less than the O.D. of the spring.
